(19) United States
(12) Patent Application Publication
(10) Pub. No.: US 2026/0063580 A1
(43) Pub. Date: Mar. 5, 2026

(54) MAGNETOCALORIC MATERIAL PROPERTY EVALUATION DEVICE

(71) Applicant: KOREA INSTITUTE OF MATERIALS SCIENCE, Gyeongsangnam-do (KR)

(72) Inventors: Jong Woo KIM, Gyeongsangnam-do (KR); Ki Hoon KANG, Gyeongsangnam-do (KR); Cheol Woo ANH, Gyeongsangnam-do (KR); A Young LEE, Seoul (KR); Jong Jin CHOI, Busan (KR); Byung Dong HAHN, Gyeongsangnam-do (KR)

(73) Assignee: KOREA INSTITUTE OF MATERIALS SCIENCE, Gyeongsangnam-do (KR)

(21) Appl. No.: 19/106,857

(22) PCT Filed: Sep. 5, 2023
(86) PCT No.: PCT/KR2023/013259

§ 371 Date: Feb. 26, 2025

(30) Foreign Application Priority Data
Sep. 20, 2022 (KR) 10-2022-0118498

(51) Int. Cl. G01N 25/20; G01K 7/02; G01K 17/08

(52) U.S. Cl. CPC G01N 25/20; G01K 7/02; G01K 17/08

(57) ABSTRACT

The present disclosure relates to a magnetocaloric material property evaluation device that may substantially accurately analyze an adiabatic temperature change in a magnetocaloric material applied to a magnetic cooling system without relying on thermodynamic calculations.

### TECHNICAL FIELD

The present disclosure relates to a magnetocaloric material property evaluation device capable of accurately analyzing an adiabatic temperature change in a magnetocaloric material (referred also to as ‘magnetic cooling material’) applied to a magnetic cooling system.

### BACKGROUND ART

Recently, a need has emerged to replace gas refrigerants (CFCs) in existing gas compression cooling systems due to international greenhouse gas (GHG) emission regulations and increasing energy consumption associated with cooling/refrigeration. Accordingly, studies on next-generation cooling systems have received significant attention. For example, magnetocaloric materials (MCMs) are a key factor as a coolant in magnetic cooling systems, which are one of the next-generation cooling systems.

Specifically, referring to FIG. 1, MCMs may exhibit a magnetocaloric effect (MCE), in which the temperature of a material increases/decreases depending on entropy changes induced by an externally applied magnetic field. Such a magnetic cooling system utilizing MCMs may be applied to household air conditioning systems, refrigeration systems, or air conditioning systems for data center server rooms.

Referring to FIG. 2, an adiabatic temperature change (ΔT_{ad}), which is a magnetocaloric effect characteristic occurring in the MCM depending on an applied magnetic field, may be a critical factor that determines the efficiency of the magnetic cooling system. The adiabatic temperature change forms a sharp peak in only a specific temperature range, depending on a base temperature.

However, hitherto, no experimental equipment has been proposed that can precisely measure adiabatic temperature changes in the MCM. In existing arts, adiabatic temperature changes have sometimes been measured using indirect resolution methods based on thermodynamic calculations, but it is difficult to obtain accurate results with such measurement methods due to relatively large experimental errors and the limitations in material property analysis.

### DISCLOSURE

### Technical Problem

To overcome the aforementioned problems, embodiments of the present disclosure are intended to provide a magnetocaloric material property evaluation device that may substantially accurately analyze an adiabatic temperature change in a magnetocaloric material applied to a magnetic cooling system without relying on thermodynamic calculations.

### Technical Solution

To achieve the above object, an aspect of the present disclosure provides a magnetocaloric material property evaluation device, including: a base plate; a holder unit installed on an upper surface of the base plate, and including therein a specimen receiving depression formed to receive a specimen to be evaluated; a magnetic field applying unit installed rotatably in a double magnet structure on an outer circumferential surface of the holder unit, and configured to selectively apply/remove a magnetic field to/from the specimen depending on a rotating angle; a temperature control unit configured to control a temperature of the specimen by circulating fluid within the holder unit; and a temperature measurement unit configured to measure an adiabatic temperature change in the specimen to/from which the magnetic field is applied/removed by the magnetic field applying unit.

In this case, the holder unit may include: a pair of supports paced on the base plate and spaced apart from each other by a set distance in a horizontal direction; a hollow rotating shaft rotatably coupled at opposite ends thereof to the supports; and a holder housing fitted and coupled along a central axis inside the rotating shaft through coupling holes of the supports without interference therebetween, and provided with the specimen receiving depression on a first side thereof and a fluid receiving space, in which the fluid circulates, on a second side thereof.

Furthermore, the holder housing may further include: a window coupled to a stepped edge of the specimen receiving depression to close and secure an opening of the specimen receiving depression after the specimen is received in the specimen receiving depression; and a hollow fixing component coupled to an inner circumferential surface of the first side of the holder housing to press and secure the window toward the specimen receiving depression.

Furthermore, the holder housing may include: a first body provided with the specimen receiving depression on a first side thereof; and a hollow second body coupled to an inner circumferential surface of a second side of the first body, and provided with the fluid receiving space therein.

Furthermore, the first body and the second body may be formed of any one material of polyoxymethylene (POM), polyetherimide (PEI), and polycarbonate (PC).

Furthermore, the magnetic field applying unit may include: an internal magnet integrally formed with the rotating shaft and rotated by a set angle when power is transmitted thereto, with a plurality of magnets arranged radially around an axial line of the rotating shaft; and an external magnet fixedly installed on the base plate to maintain a set gap with an outer circumferential surface of the internal magnet, with a plurality of magnets arranged radially around the rotating shaft to respectively correspond to the magnets of the internal magnet.

Furthermore, in the magnetic field applying unit, while the internal magnet rotates by a set angle at a time, in case that magnetization directions of the magnets that respectively constitute the internal magnet and the external magnet are identical to each other, a magnetic field may be applied, and in case that magnetization directions of the magnets that respectively constitute the internal magnet and the external magnet are opposite to each other, the magnetic field may be removed.

Furthermore, the temperature control unit may include a fluid supply mechanism configured to supply and circulate fluid via a supply pipe and a return pipe that are installed in the fluid receiving space in an axial direction.

Furthermore, the supply pipe may be placed to extend farther toward the specimen receiving depression than the return pipe in the fluid receiving space.

Furthermore, the temperature measurement unit may include a temperature measurement device disposed on an axial line identical to the specimen receiving depression and configured to measure an adiabatic temperature change in the specimen.

Furthermore, the temperature measurement device may be adjustable in position in X-, Y-, and Z-axial directions along a guide rail.

Furthermore, the temperature measurement unit may further include a contact thermometer connected to an interior of the specimen receiving depression via a thermocouple line and configured to measure an adiabatic temperature change in the specimen.

### Advantageous Effects

In a magnetocaloric material property evaluation device having the aforementioned configuration according to the present disclosure, a magnetic field may be easily applied to/removed from a specimen depending on a driving angle of a magnetic field applying unit installed in a double structure, and adiabatic temperature changes in the specimen to which the magnetic field is applied to/removed from may be measured in real time by a temperature measurement unit. Accordingly, an advantage of accurately analyzing the properties of the magnetocaloric material may be provided.

Furthermore, because externally circulated fluid is used to control the temperature of the specimen, the structure of the device may be simplified compared to the case where a temperature control unit is located internally, and interference from a magnetic field may be avoided, thereby ensuring operational reliability of the device.

In addition, as water is used as fluid for adjusting the temperature, efficient temperature control at room temperature may be achieved.

### BRIEF DESCRIPTION OF DRAWINGS

FIG. 1 is a schematic view illustrating a magnetic cooling system to which a general magnetocaloric material (MCM) is applied.

FIG. 2 is a graph showing properties of the MCM applied in FIG. 1.

FIGS. 3 and 4 are perspective views of a magnetocaloric material (MCM) property evaluation device according to the present disclosure.

FIG. 5 is a side view of the MCM property evaluation device according to the present disclosure.

FIGS. 6 to 8 are perspective views illustrating a holder coupling structure according to the present disclosure.

FIGS. 9 and 10 are a sectional view and an exploded view illustrating an internal structure of a holder housing according to the present disclosure.

FIGS. 11 to 15 are views illustrating the structure and operating principle of a magnetic field applying unit according to the present disclosure.

FIG. 16 is a sectional view illustrating a principal portion of a temperature control unit according to the present disclosure.

FIG. 17 illustrates results of repeatedly measuring adiabatic temperature changes of gadolinium (Gd), which is a representative MCM, using the MCM property evaluation device according to the present disclosure.

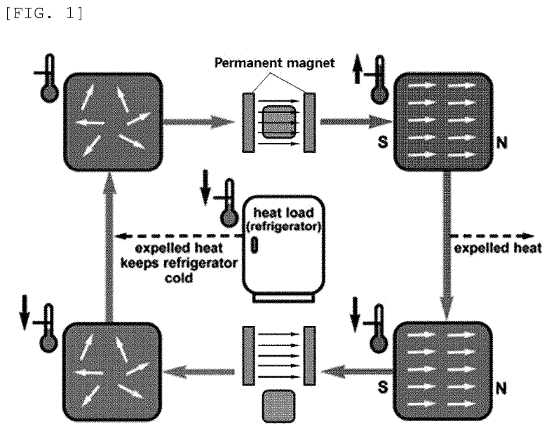

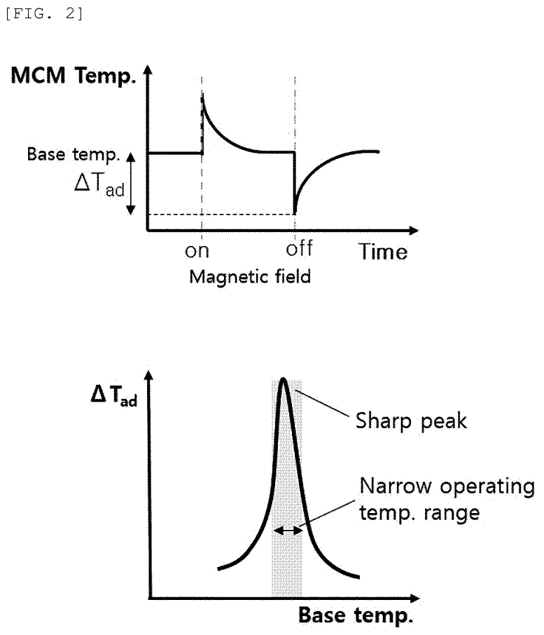

### DESCRIPTION OF THE REFERENCE NUMERALS

| | |
|---|---|
| 1: MCM property evaluation device | M: Specimen |
| 100: Base plate | 110: Handle |
| 200: Holder unit | 210: Support |
| 211: Specimen measurement hole | 213: Coupling hole |
| 220: Rotating shaft | 230: Holder |
| housing | |
| 230a: First body | 230b: Second body |
| 231: Specimen receiving depression | 231a: Stepped edge |
| 233: Fluid receiving space | 235: Window |
| 237: Fixing component | 239: O-ring |
| 300: Magnetic field applying unit | 310: Internal |
| magnet | |
| 320: External magnet | 330: Stepper motor |
| 331: Timing belt | 333: Pulley |
| 400: Temperature control unit | 410: Fluid supply |
| mechanism | |
| 411: Supply pipe | 413: Return pipe |
| 500: Temperature measurement unit | 510: Temperature |
| measurement device | |
| 511: Guide rail | 520: Contact |
| thermometer | |
| 521: Thermocouple line | |

### MODE FOR INVENTION

Hereinafter, with reference to the accompanying drawings, a detailed description of the configuration and operation of specific embodiments of the present disclosure is as follows.

Here, it should be noted that in adding reference numerals to components of each drawing, the same components are marked with the same numerals as much as possible, even if the components are shown on different drawings.

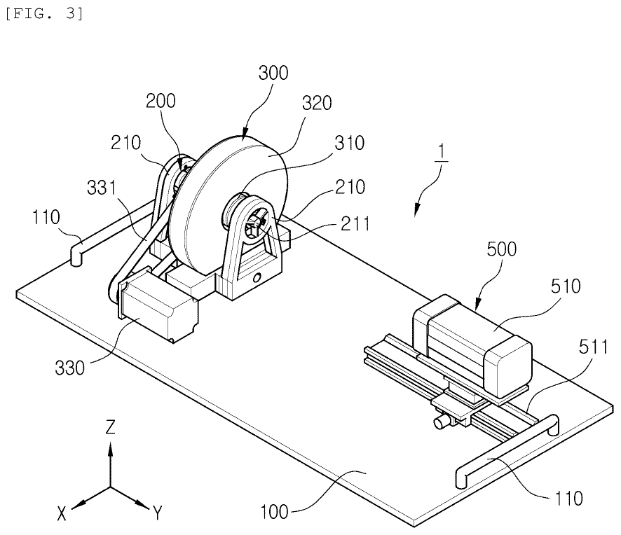

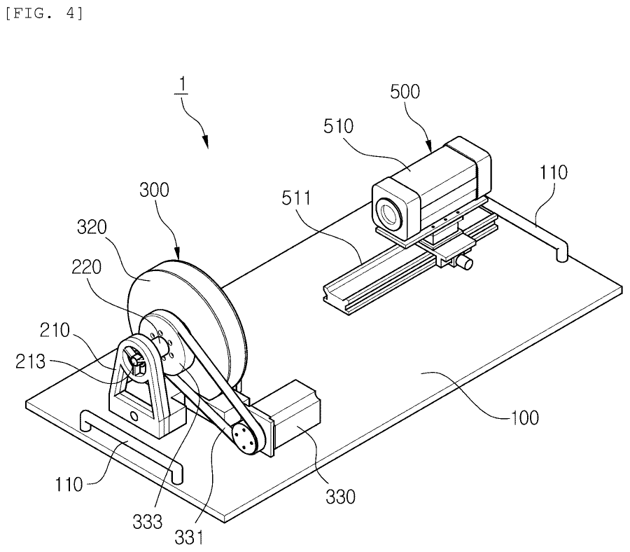

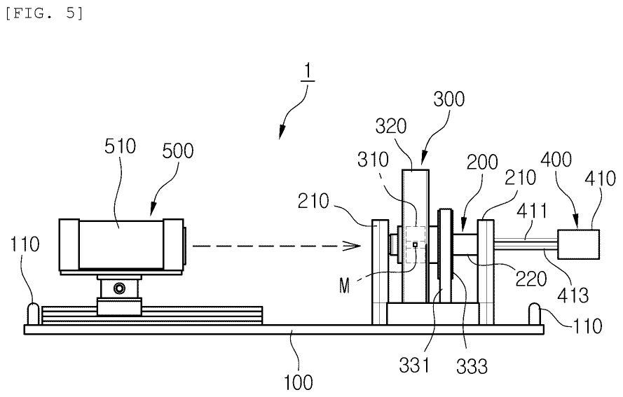

FIGS. 3 and 4 are perspective views of a magnetocaloric material (MCM) property evaluation device according to the present disclosure. FIG. 5 is a side view of the MCM property evaluation device according to the present disclosure.

Referring to FIGS. 3 and 4, the MCM property evaluation device 1 according to an embodiment of the present disclosure may include a base plate 100, a holder unit 200, a magnetic field applying unit 300, a temperature control unit 400, and a temperature measurement unit 500.

A detailed description of the configuration of the present disclosure is as follows.

First, the base plate 100 may constitute a main lower frame of the device, and may be formed of a flat plate with a predetermined area. Handles 110 may be provided on opposite sides of the base plate 100 to facilitate transportation.

The holder unit 200 may be installed on an upper surface of the base plate 100, and may include a specimen receiving depression 231 therein, into which a specimen M to be evaluated can be received. The specimen M may be provided in the form of powder or bulk.

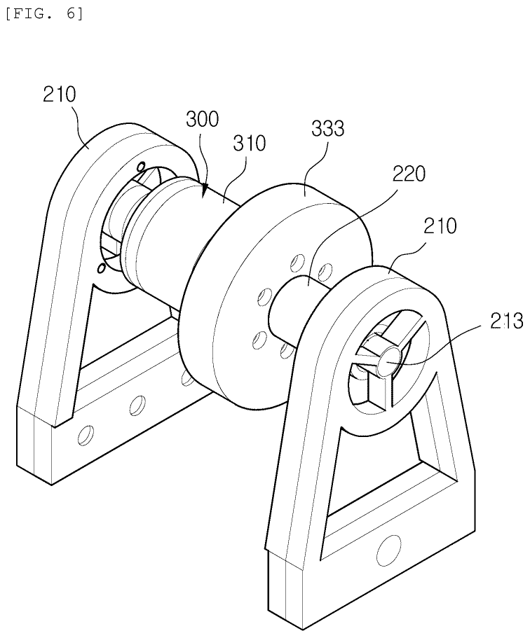

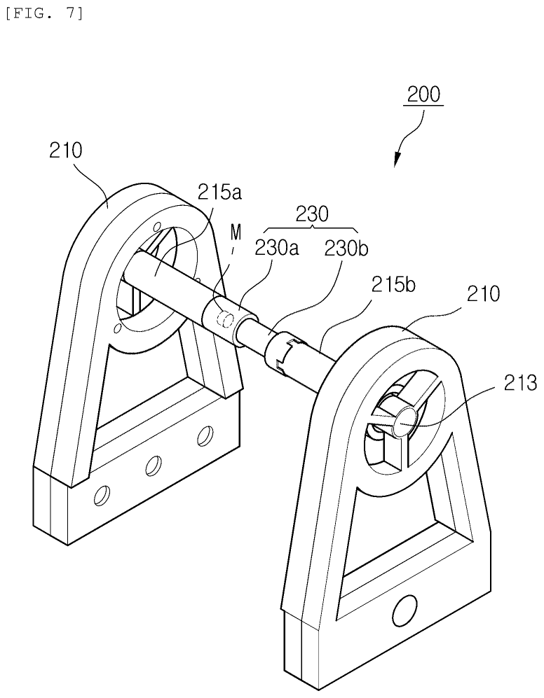

Specifically, referring to FIGS. 5 and 6, the holder unit 200 may include at least one pair of supports 210 that are disposed on the base plate 100 at positions spaced apart from each other by a certain distance in a horizontal direction, a hollow rotating shaft 220 that is rotatably coupled on opposite ends thereof to the supports 210 by bearings, and a holder housing 230 (refer to FIG. 7) that is fitted and coupled along a central axis inside the rotating shaft 220 without interference therewith.

Referring to FIG. 7, the holder housing 230 may be coupled to the supports 210 in such a way that opposite ends of the holder housing 230 are inserted into hollow fixed pipes 215a and 215b that protrude certain lengths in an axial direction from respective facing surfaces of the supports 210.

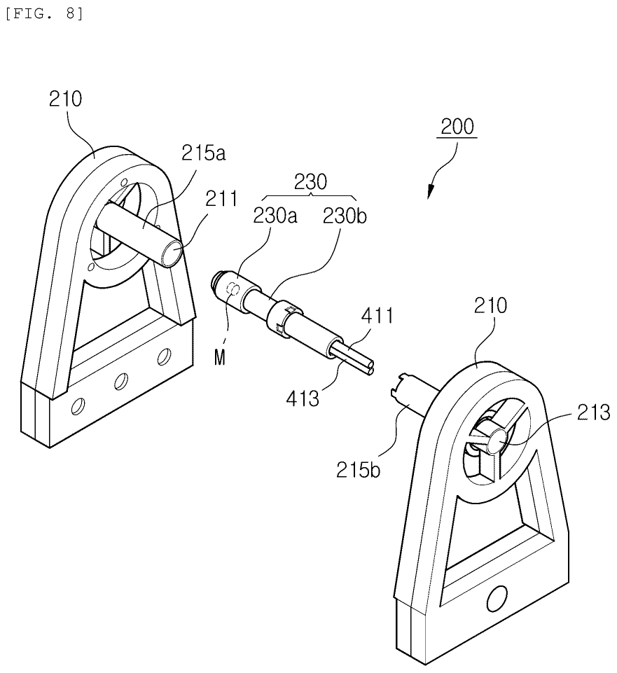

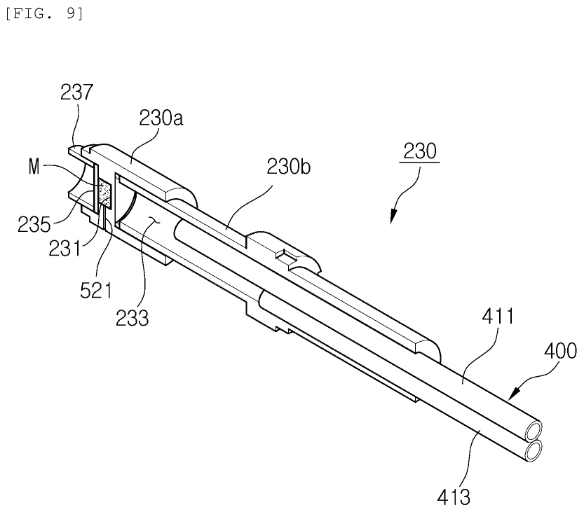

Referring to FIGS. 8 and 9, the holder housing 230 may include, on a first side which is fitted to the fixed pipe 215a of the support 210, the specimen receiving depression 231 in which the specimen M is received, and may include, on a second side, a fluid receiving space 233 formed to allow fluid to circulate through the temperature control unit 400, which will be described later.

Communicating with the first side of the holder housing 230, a specimen measurement hole 211 (refer to FIG. 8) may be formed in the fixed pipe 215a of the first-side support 210. Therefore, it is possible to measure the status of the specimen M received in the specimen receiving depression 231 (refer to FIG. 9) of the holder housing 230 through the specimen measurement hole 211.

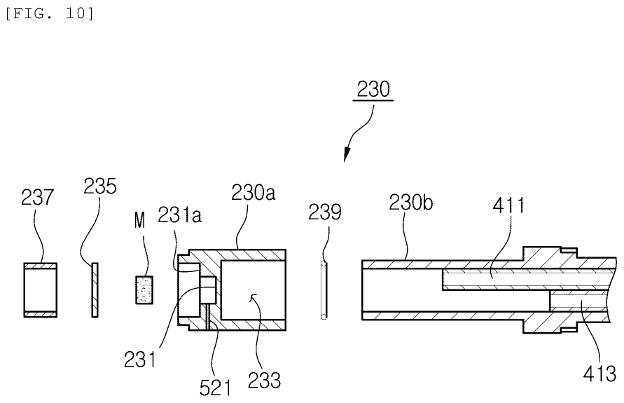

Referring specifically to FIG. 10, the holder housing 230 may include a window 235 which is coupled to a stepped edge 231a of the specimen receiving depression 231 to close and secure an opening of the specimen receiving depression 231 after the specimen M is received in the specimen receiving depression 231, and a hollow fixing component 237 which is coupled to an inner circumferential surface of one side of the holder housing 230 to press and secure the window 235 toward the specimen receiving depression 231.

In this case, the holder housing 230 may include a first body 230a having the specimen receiving depression 231 on a first side thereof, and a hollow second body 230b which is threaded into an inner circumferential surface of a second side of the first body 230a with the fluid receiving space 233 formed in the second body 230b. In this case, an O-ring 239 may be interposed between coupling portions of the first body 230a and the second body 230b, thereby enhancing the watertightness. In the present disclosure, although an example has been described in which the second body 230b is threaded into the inner circumferential surface of the second side of the first body 230a, the present disclosure is not limited thereto, and a modification may be applied in which the second body 230b is fitted into the inner circumferential surface of the second side of the first body 230a.

The magnetocaloric effect may vary depending on the temperature of the specimen M, and temperature changes are required to be measured under adiabatic conditions. To this end, the first body 230a and the second body 230b may be formed of materials with relatively low thermal conductivity. For example, the first body 230a and the second body 230b may be formed of any one material of polyoxymethylene (POM), polyetherimide (PEI), and polycarbonate (PC), which are high-strength materials with low thermal conductivity. In an embodiment of the present disclosure, a POM material, which is easily obtainable and affordable, may be used. Accordingly, heat of fluid that circulates in the fluid receiving space 233 in the second body 230b may be focused on the specimen receiving depression 231 in the first body 230a, whereby the temperature of the specimen M can be efficiently controlled through overall temperature adjustment of the first body 230a.

In other words, as the first body 230a and the second body 230b are formed of materials with relatively low thermal conductivity, temperature changes in the specimen M may be minimized from leaking to the outside. In this case, in the present disclosure, although an example has been described in which the first body 230a and the second body 230b are formed of any one of POM, PEI, and PC, a modification may be applied in which other materials with relatively low thermal conductivity are applied.

Furthermore, in an embodiment, the window 235 may be made of a material that allows infrared rays, which are irradiated from the temperature measurement unit 500 to be described later, to pass therethrough easily.

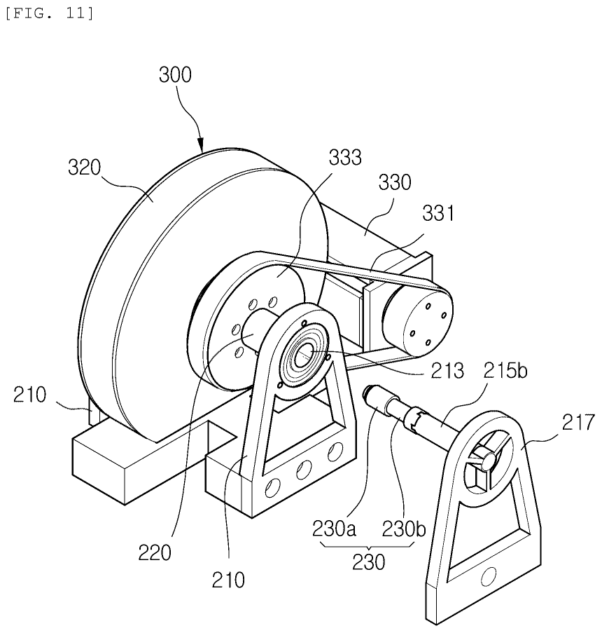

Referring to FIG. 11, a coupling hole 213 that communicates with an interior of the rotating shaft 220 may be formed in the second-side support 210 of the holder housing 230 to allow the holder housing 230 to be easily separated from or fitted into the interior of the rotating shaft 220.

In this case, the second-side support 210 may be provided with an auxiliary support 217 to facilitate the separation or coupling of the holder housing 230. The auxiliary support 217 may be integrally formed with a fixed pipe 215b, into which the second side of the holder housing 230 is fitted. Therefore, after the second side of the holder housing 230 is fixed to the fixed pipe 215b of the auxiliary support 217, a first-side end of the holder housing 230 may be coupled to the second-side support 210 by being inserted into the coupling hole 213 of the second-side support 210. After the auxiliary support 217 is coupled to the second-side support 210, the position of the auxiliary support 217 may be fixed by a separate fastening component (not illustrated).

The magnetic field applying unit 300 may selectively apply/remove a magnetic field to/from the specimen M received in the specimen receiving depression 231 depending on a rotating angle. The magnetic field applying unit 300 may be rotatably installed on an outer circumferential surface of the holder unit 200 in a double magnet structure.

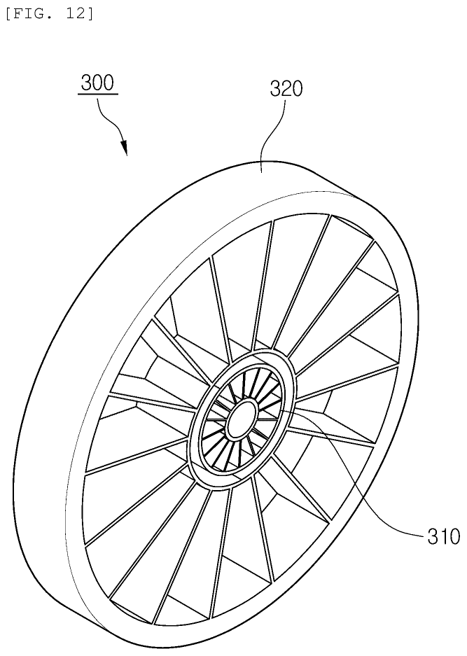

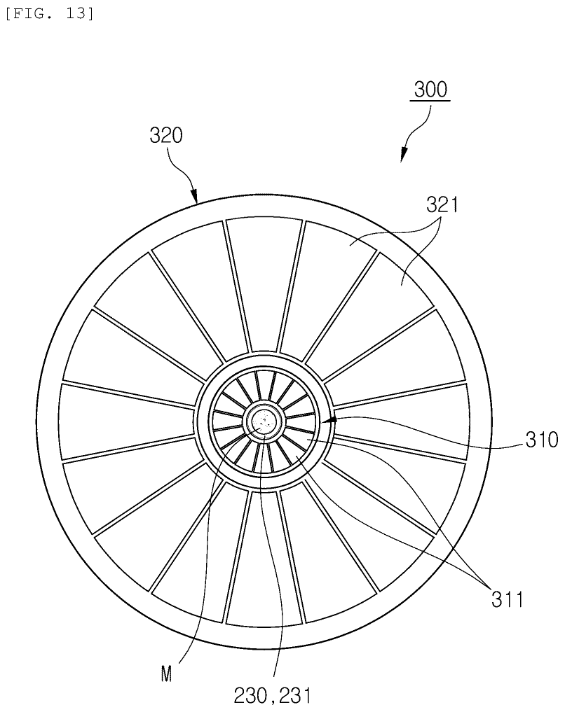

In detail, referring to FIGS. 12 and 13, the magnet field applying unit 300 may include an internal magnet 310 that is integrally formed with the rotating shaft 220 and rotated by a certain angle when power is transmitted thereto, and provided with a plurality of magnets 311 arranged radially around an axial line of the rotating shaft 220, and an external magnet 320 that is fixedly installed on the base plate 100 to maintain a certain gap with an outer circumferential surface of the internal magnet 310.

In this case, the external magnet 320 may include a plurality of magnets 321 that are arranged radially around the rotating shaft 220 to respectively correspond to the magnets 311 of the internal magnet 310.

Furthermore, the internal magnet 310 and the external magnet 320 may partition space for receiving the plurality of magnets 311 and 321 into a plurality of spaces using partitions each having a certain thickness (e.g., 2 mm). In other words, the internal magnet 310 and the external magnet 320 that constitute the magnet field applying unit 300 may employ a Halbach array structure. In this case, the specimen M may be positioned on an internal central axis of the internal magnet 310.

Referring again to FIG. 11, the internal magnet 310 may receive rotational power of a stepper motor 330 through a pulley 333 integrally formed on the rotating shaft 220 via a timing belt 331, and rotate by a certain angle.

In this case, in the present disclosure, although an example has been illustrated and described in which the external magnet 320 is stationary and the internal magnet 310 (refer to FIG. 12) is installed so as to be rotatable by a certain angle, conversely, a modification may also be applied in which the internal magnet 310 is stationary and the external magnet 320 is installed so as to be rotatable by a certain angle.

The magnetic field applying unit 300 having the aforementioned structure may be operated in such a way that the internal magnet 310 receives power from the stepper motor 330 and rotates by a certain angle (e.g., 180°) at a time.

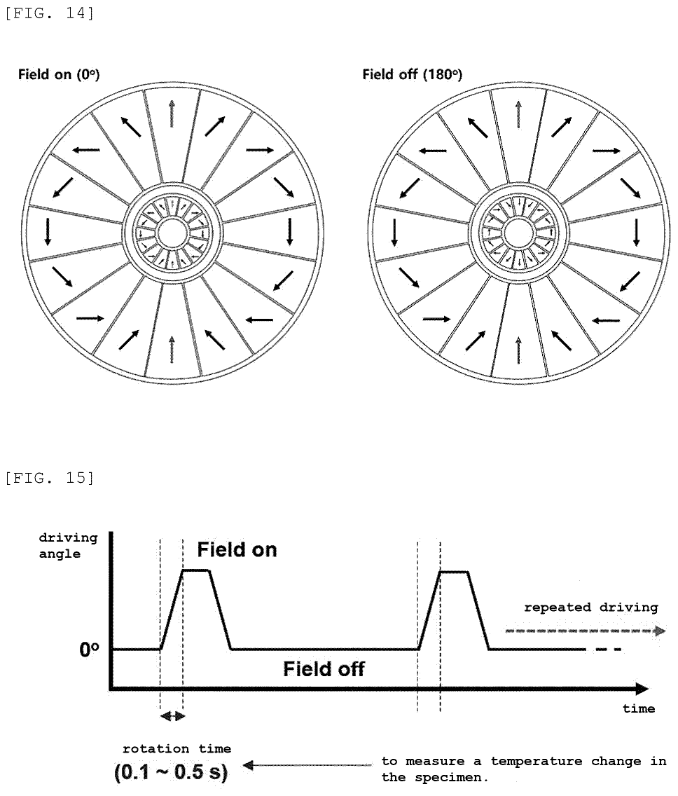

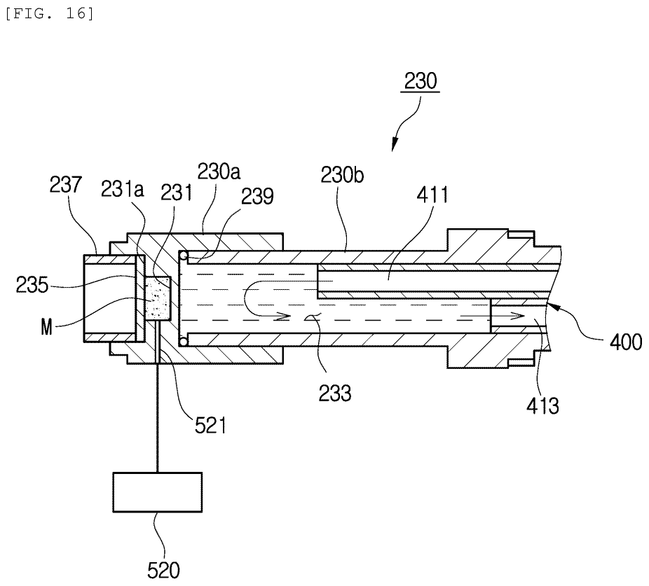

Specifically, referring to FIGS. 14 and 15, in the case where magnetization directions of the magnets 311 and 321 that respectively constitute the internal magnet 310 and the external magnet 320 are the same, a magnetic field may be applied (Field on) at 0°. In the case where the magnetization directions of the magnets 311 and 321 that respectively constitute the internal magnet 310 and the external magnet 320 are opposite to each other, the magnetic field may be removed (Field off) at 180°.

Furthermore, a rotation time of the internal magnet 310 may range from 0.1 seconds to 0.5 seconds, and processes of applying and removing the magnetic field to/from the specimen M may be repeatedly driven.

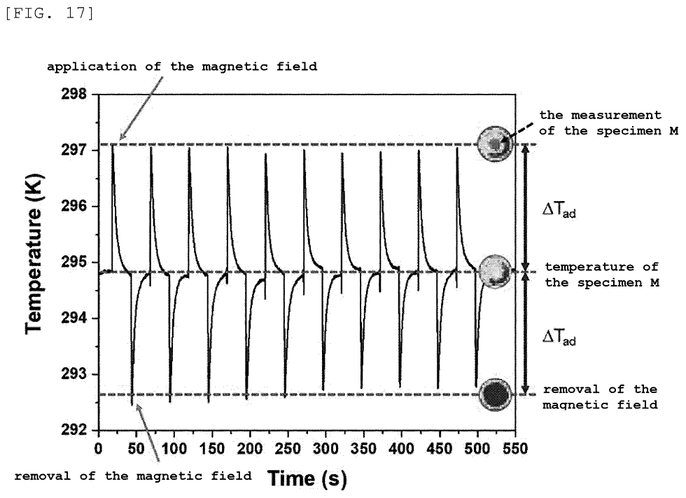

Referring to FIG. 16, the temperature control unit 400 may control the temperature of the specimen M received in the specimen receiving depression 231 by circulating fluid in the holder unit 200.

Specifically, the temperature control unit 400 may include a fluid supply mechanism 410 that is configured to supply and circulate fluid via a supply pipe 411 and a return pipe 413 that are installed in the fluid receiving space 233 in an axial direction. In an embodiment, the fluid supply mechanism 410 (refer to FIG. 5) may employ a chiller, and water (distilled water) may be used as fluid.

In this case, by using water as the fluid supplied through the fluid supply mechanism 410, the structure of the holder unit 200 in which the specimen M is receive may be simplified.

Particularly, in existing temperature control units, electricity is used to control the temperature of specimen M, which may affect surrounding components. However, in the temperature control unit 400 according to the present disclosure, the fluid supply mechanism 410, which employs water instead of electricity, may be used, thereby minimizing influence on other components. In addition, interference caused by magnetic fields may be avoided, thereby ensuring the operational reliability of the device.

Furthermore, in the case where the specimen M to be analyzed needs to be measured at sub-zero temperatures, fluid containing some antifreeze agents, such as ethylene glycol, may be used. In other words, the supplied fluid may selectively employ a coolant, such as water or ethylene glycol.

The supply pipe 411 may be placed to extend farther toward the specimen receiving depression 231 than the return pipe 413 in the fluid receiving space 233. Accordingly, fluid supplied to the fluid receiving space 233 through the supply pipe 411 may circulate smoothly within the fluid receiving space 233, rather than being directly discharged through the adjacent return pipe 413.

Referring again to FIG. 3, the temperature measurement unit 500 may measure adiabatic temperature changes in the specimen M to/from which a magnetic field is applied/removed by the magnetic field applying unit 300.

Specifically, the temperature measurement unit 500 may include a temperature measurement device 510 that is disposed on the same axial line as the specimen receiving depression 231 to measure adiabatic temperature changes in the specimen M. The temperature measurement device 510 may irradiate infrared rays to the specimen M through the specimen measurement hole 211 of the holder unit 200 to measure the temperature of the specimen M (refer to FIG. 5).

In this case, the position of the temperature measurement device 510 may be adjustable in X-, Y-, and Z-axial directions along guide rails 511 (only the Y-axial guide rail 511 is shown for the sake of convenience in explanation). In the present disclosure, although an example has been described in which the position of the temperature measurement device 510 is manually adjusted along the guide rail 511, an actuator may be used to implement automatic position adjustment.

Furthermore, as illustrated in FIG. 16, the temperature measurement unit 500 may include a contact thermometer 520 that is connected to the interior of the specimen receiving depression 231 via a thermocouple line 521 to measure adiabatic temperature changes in the specimen M. Accordingly, the non-contact temperature measurement device 510 and the contact thermometer 520 may simultaneously measure the temperature of the specimen M, which changes rapidly as the magnetic field is applied to/removed from the specimen M, thereby enabling accurate analysis of the adiabatic temperature changes of the specimen M.

The operation of the MCM property evaluation device 1 according to the present disclosure having the aforementioned configuration will be described.

First, the holder housing 230 is withdrawn from the rotating shaft 220 through the second side of the support 210 of the holder unit 200, and the specimen receiving depression 231 thereafter opens.

Subsequently, the specimen M to be evaluated in the form of powder or bulk is received in the specimen receiving depression 231, and then the window 235 is used to close the opening of the specimen receiving depression 231 and secured in position by a fixing component 237.

Subsequently, the holder housing 230, in which the specimen M is received, is fitted into the rotating shaft 220 and disposed such that the specimen M is positioned on a central axis of the magnetic field applying unit 300.

Thereafter, a base temperature of the specimen M may be adjusted by supplying fluid to the fluid receiving space 233 in the holder housing 230 through the temperature control unit 400.

If the specimen M reaches a measurement temperature, cycle driving conditions of the magnetic field applying unit 300 are set, and then the magnetic field applying unit 300 is operated to perform a magnetic field applying/removing process.

In addition, an adiabatic temperature change (ΔT_{ad}) of the specimen M may be measured through the temperature measurement device 510 and the contact thermometer 520 of the temperature measurement unit 500.

FIG. 17 illustrates results of repeatedly measuring adiabatic temperature changes of gadolinium (Gd), which is a representative MCM, using the MCM property evaluation device 1 according to the present disclosure.

Referring to FIG. 17, in the present experiment, the temperature changes of the specimen M, occurring according to the magnetic field applying/removing process during cycle driving based on the measurement temperature (=initial temperature or reference temperature) of the specimen M, were measured in non-contact/contact manners through the temperature measurement device 510 and the contact thermometer 520, respectively (colored image: non-contact measurement, and graph: contact measurement).

As a result, it was confirmed that during repeated measurement, temperature increase/decrease of the specimen M itself, depending on the application/removal of the magnetic field at the measurement temperature of the specimen M, was stably measured.

While the present disclosure has been described with reference to specific embodiments, the present disclosure is not limited thereto, and it is obvious that various changes and modifications may be made within technical ideas of the present disclosure.

1. A magnetocaloric material property evaluation device, comprising:
a base plate;
a holder unit installed on an upper surface of the base plate, and including therein a specimen receiving depression formed to receive a specimen to be evaluated;
a magnetic field applying unit installed rotatably in a double magnet structure on an outer circumferential surface of the holder unit, and configured to selectively apply/remove a magnetic field to/from the specimen depending on a rotating angle;
a temperature control unit configured to control a temperature of the specimen by circulating fluid within the holder unit; and
a temperature measurement unit configured to measure an adiabatic temperature change in the specimen to/from which the magnetic field is applied/removed by the magnetic field applying unit.

2. The magnetocaloric material property evaluation device of claim 1, wherein the holder unit comprises:
a pair of supports paced on the base plate and spaced apart from each other by a set distance in a horizontal direction;
a hollow rotating shaft rotatably coupled at opposite ends thereof to the supports; and
a holder housing fitted and coupled along a central axis inside the rotating shaft through coupling holes of the supports without interference therebetween, and provided with the specimen receiving depression on a first side thereof and a fluid receiving space, in which the fluid circulates, on a second side thereof.

3. The magnetocaloric material property evaluation device of claim 2, wherein the holder housing further comprises:
a window coupled to a stepped edge of the specimen receiving depression to close and secure an opening of the specimen receiving depression after the specimen is received in the specimen receiving depression; and
a hollow fixing component coupled to an inner circumferential surface of the first side of the holder housing to press and secure the window toward the specimen receiving depression.

4. The magnetocaloric material property evaluation device of claim 2, wherein the holder housing comprises:
a first body provided with the specimen receiving depression on a first side thereof; and
a hollow second body coupled to an inner circumferential surface of a second side of the first body, and provided with the fluid receiving space therein.

5. The magnetocaloric material property evaluation device of claim 4, wherein the first body and the second body are formed of any one material of polyoxymethylene (POM), polyetherimide (PEI), and polycarbonate (PC).

6. The magnetocaloric material property evaluation device of claim 2, wherein the magnetic field applying unit comprises:
an internal magnet integrally formed with the rotating shaft and rotated by a set angle when power is transmitted thereto, with a plurality of magnets arranged radially around an axial line of the rotating shaft; and
an external magnet fixedly installed on the base plate to maintain a set gap with an outer circumferential surface of the internal magnet, with a plurality of magnets arranged radially around the rotating shaft to respectively correspond to the magnets of the internal magnet.

7. The magnetocaloric material property evaluation device of claim 6, wherein in the magnetic field applying unit,
while the internal magnet rotates by a set angle at a time, in case that magnetization directions of the magnets that respectively constitute the internal magnet and the external magnet are identical to each other, a magnetic field is applied, and
in case that magnetization directions of the magnets that respectively constitute the internal magnet and the external magnet are opposite to each other, the magnetic field is removed.

8. The magnetocaloric material property evaluation device of claim 2, wherein the temperature control unit comprises a fluid supply mechanism configured to supply and circulate fluid via a supply pipe and a return pipe that are installed in the fluid receiving space in an axial direction.

9. The magnetocaloric material property evaluation device of claim 8, wherein the supply pipe is placed to extend farther toward the specimen receiving depression than the return pipe in the fluid receiving space.

10. The magnetocaloric material property evaluation device of claim 1, wherein the temperature measurement unit comprises a temperature measurement device disposed on an axial line identical to the specimen receiving depression and configured to measure an adiabatic temperature change in the specimen.

11. The magnetocaloric material property evaluation device of claim 10, wherein the temperature measurement device is adjustable in position in X-, Y-, and Z-axial directions along a guide rail.

12. The magnetocaloric material property evaluation device of claim 10, wherein the temperature measurement unit further comprises a contact thermometer connected to an interior of the specimen receiving depression via a thermocouple line and configured to measure an adiabatic temperature change in the specimen.

13. The magnetocaloric material property evaluation device of claim 3, wherein the holder housing comprises:
a first body provided with the specimen receiving depression on a first side thereof; and
a hollow second body coupled to an inner circumferential surface of a second side of the first body, and provided with the fluid receiving space therein.

14. The magnetocaloric material property evaluation device of claim 13, wherein the first body and the second body are formed of any one material of polyoxymethylene (POM), polyetherimide (PEI), and polycarbonate (PC).
